(19) United States
(12) Patent Application Publication
(10) Pub. No.: US 2022/0382825 A1
(43) Pub. Date: Dec. 1, 2022

(54) METHOD AND SYSTEM FOR WEB PAGE CO-BROWSING

(71) Applicants: Ihor Olehovych KORIAKA, Kyiv City (UA); Ivan Valeriiovych STARODUBTSEV, Kyiv City (UA)

(72) Inventors: Ihor Olehovych KORIAKA, Kyiv City (UA); Ivan Valeriiovych STARODUBTSEV, Kyiv City (UA)

(21) Appl. No.: 17/377,702

(22) Filed: Jul. 16, 2021

(30) Foreign Application Priority Data
May 25, 2021 (UA) A 2021 02752

(51) Int. Cl. G06F 16/957; G06F 16/958; G06F 16/9538

(52) U.S. Cl. CPC G06F 16/9577; G06F 16/9574; G06F 16/958; G06F 16/9538

(57) ABSTRACT

The invention relates to devices and methods for co-browsing a web page, namely, to the field of data processing systems that allow multiple end users to simultaneously browse the same website from different locations and devices in a virtual room. A system for co-browsing a web page is proposed, comprising a sharing confirmation module; a platform login verification module; a virtual room creation module; a sharing determination module; a data communication module, configured to provide content to the shared platform for sharing; an event communication module; a module for executing and displaying events on the end-user device. The proposed method comprises the steps of: accepting the shared content selected by the user and the shared platform selected by the user; navigating to the unified verification interface so that a user can log into the shared platform through the unified verification interface; creating a virtual room for co-browsing, and assigning a unique room ID to it, and saving the room ID for all participants; receiving an instruction from the user to perform an action on the web page; capturing the action via browser event handler; transforming the action and its properties into a JSON message; sending the specified message to the system server via the WebSockets protocol; receiving the message by means of the room end-user device, and refreshing the web page to display the updated website state.

### FIELD OF INVENTION

The disclosure of the invention generally relates to the field of data processing systems that allow multiple end users to simultaneously browse the same website from different locations and devices in a virtual room.

### BACKGROUND OF THE INVENTION

A method of sharing web pages between a server and a client is known from the prior art (Chinese Patent No. 102891897 “Webpage sharing method, server and client”, IPC: H04L 29/08, G06F 17/30, date of filing: 30 Oct. 2012). Co-browsing/shared access allows two or more users who are in different locations to interact through the same web page/browser session without requiring to log in. According to the technical scheme, without logging in to a third-party website or to another application program, the user achieves that the web page is shared in real time.

Patent CN104504004B (Chinese Patent No. 104504004 “Method and device for website sharing”, IPC: G06F 17/30, date of filing: 09 Dec. 2014) describes a method and a device for website sharing. The method of website sharing comprises the following: when a website sharing function is triggered, information on access to the shared content is recorded on a remote server. Users synchronously navigate to a social media sharing platform to share the shared content, where the shared content is a website's shared content.

U.S. Pat. No. 10,067,729 “Systems and methods for enabling internet co-browsing” (IPC: G06F 9/54, G06F 3/14, G06F 17/30, G06F 17/22, date of filing: 11 Nov. 2015) discloses systems and methods for enabling co-browsing. A device, such as a web server, may execute a browser application that initiates co-browsing capabilities between a host computing device and one or more guest computing devices.

Activatable code is injected and/or otherwise embedded in one or more web pages. Subsequently, using the activatable code, web browser information on the host computing device is obtained and processed for display on the one or more guest computing devices. During the co-browsing session comprising an exact reproduction of the portion of the webpage at the second web browser, wherein the exact reproduction includes a pixel-by-pixel rendering of the portion of the webpage comprising at least one of images, text, and multimedia from the portion of the web page displayed within the first web browser, and at least one of mouse position, mouse movement, and scroll position from the host computing device. A virtual “Room” represents a private communications channel enabling the host computing device to transmit its viewport and all other communications such as mouse position, mouse movement, page scrolling, page refresh, chat messages, privacy mode, a guest and session end (i.e. Room close) to and from both the application server and guest computing devices.

U.S. Pat. No. 9,736,213 “Integrating co-browsing with other forms of information sharing” (IPC: H04L 29/06, H04L 29/08, G06F 17/30, G06F 17/22, G06Q 30/00, H04L 12/58, G06F 3/0484, date of filing: 16 Jan. 2015) describes a co-browsing service that uses JavaScript to enable remote viewing of a web page shown in a user's browser. Updates to the web page are rendered into HTML and forwarded on the co-browse session. Aspects of the web page that should not be visible are specified in a list of masked elements which prevents the JavaScript from transmitting the content of those elements on the co-browse session. A person viewing the web page at the remote location can select objects to have those objects highlighted within the user's browser. Likewise the person viewing the web page may manipulate the objects by selecting objects and entering information into the objects. Updates to the web page are collected and aggregated such that only the most recent updates are forwarded on the co-browse session. These updates include, for example, the hover state, and are also transmitted on the session.

The known solutions have the following drawbacks:
transmission of events and/or data occurs with some delay, that is, the end user does not always see what the initiator of the event has created;
possibility to simultaneously manage events by two or more users is not provided;
separate connection to the website being co-browsed is not implemented.

The technical result is the creation of a system providing a separate connection to a website that is co-browsed, and automatic real-time display of events occurring on the user's device, on a plurality of end-users devices.

### SUMMARY OF THE INVENTION

The object of the present invention is to provide a system and a method for online co-browsing of web pages, and at least to partially solve one or more of the problems arising from the limitations and drawbacks of the prior art.

The present invention provides a system for co-browsing a web page comprising:

a sharing confirmation module, configured to receive the shared content selected by the user and the shared platform selected by the user;

a platform login verification module, configured for navigation to a unified verification interface to verify a registered user and the user's logging into the shared platform through the unified verification interface; and

a virtual room creation module, configured to activate a code on an electronic device to create one or more private co-browsing rooms, the room being generated on request of one of the users and representing all software components and/or infrastructure that are required for screen sharing, and/or co-browsing, and/or supporting voice and video communication;

a sharing determination module, configured to determine a room member who initializes a co-browsing session and to automatically display the content of the session on electronic devices of end user-members;

a data communication module, configured to provide content to the shared platform for sharing;

an event communication module, configured to generate a record of user actions, the record including events of an input device (a mouse, a scroll, a keyboard, a touchpad, Drag and Drop) and visual events, and said events being saved in the “JavaScript Object Notation” (JSON) format, and to send events to the system server as a message via a web connection;

a module for executing and displaying events on the end-user device, configured to transmit events from the system server to the end-users devices.

Other aspect of the invention relates to a method for co-browsing a web page, which comprises the steps of:

accepting the shared content selected by the user and the shared platform selected by the user;

navigating to the unified verification interface so that a user can log into the shared platform through the unified verification interface;

creating a virtual room for co-browsing, and assigning a unique room ID to it, and saving the room ID for all participants;

receiving an instruction from the user to perform an action on the web page;

capturing the action via browser event handler;

transforming the action and its properties into a JSON message;

sending the specified message to the system server via the WebSockets protocol;

receiving the message by means of the room end-user device, and refreshing the web page to display the updated website state.

### BRIEF DESCRIPTION OF THE DRAWINGS

FIG. 1 illustrates an environment in which devices with communication capabilities interact over a network.

FIG. 2 is a block diagram illustrating an electronic device according to the embodiments of the present invention.

FIG. 3 is an example of a common way to communicate using WebSockets.

FIG. 4 shows the structure of a web co-browsing system.

FIG. 5 shows the structure of module 305.

FIG. 6 shows the structure of module 306.

### DETAILED DESCRIPTION

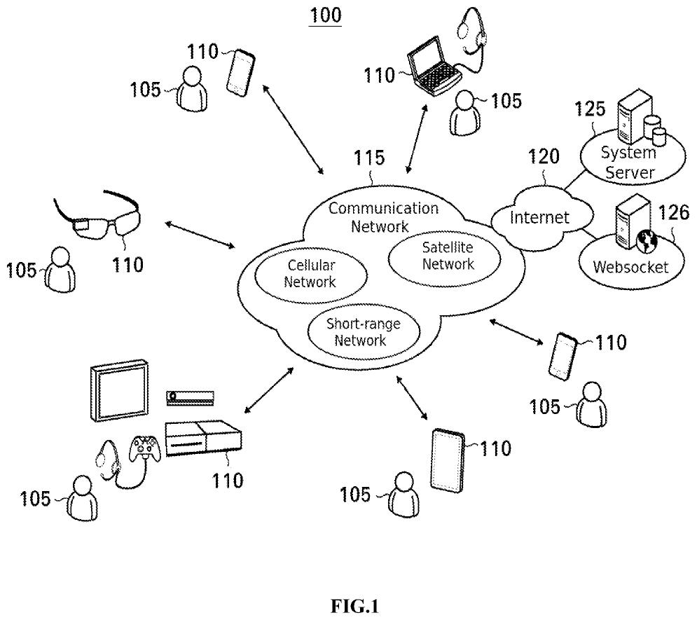

With reference to the drawings, FIG. 1 illustrates an environment 100 of communication devices in which various users 105 use respective electronic devices 110 communicating over a communications network 115. Devices 110 may include, for example, user equipment, tablet computers and smartphones, which users often use to make and accept voice and/or multimedia calls (for example, video calls), to participate in messaging (for example, text messages), to use applications, and for access to services that use data, and for browsing the World Wide Web, etc.

As shown in FIG. 1, devices 110 can access communications network 115 to implement various user experiences. A communications network can include any of a variety of types of networks and network infrastructure in various combinations or subcombinations, including cellular networks, satellite networks, IP (Internet Protocol) networks such as Wi-Fi and Ethernet networks, and/or short-range networks such as Bluetooth networks. The network infrastructure can be supported by, for example, mobile operators, companies, Internet service providers (ISPs), information service providers, etc. The communications network 115 typically includes interfaces that support a connection to the Internet 120.

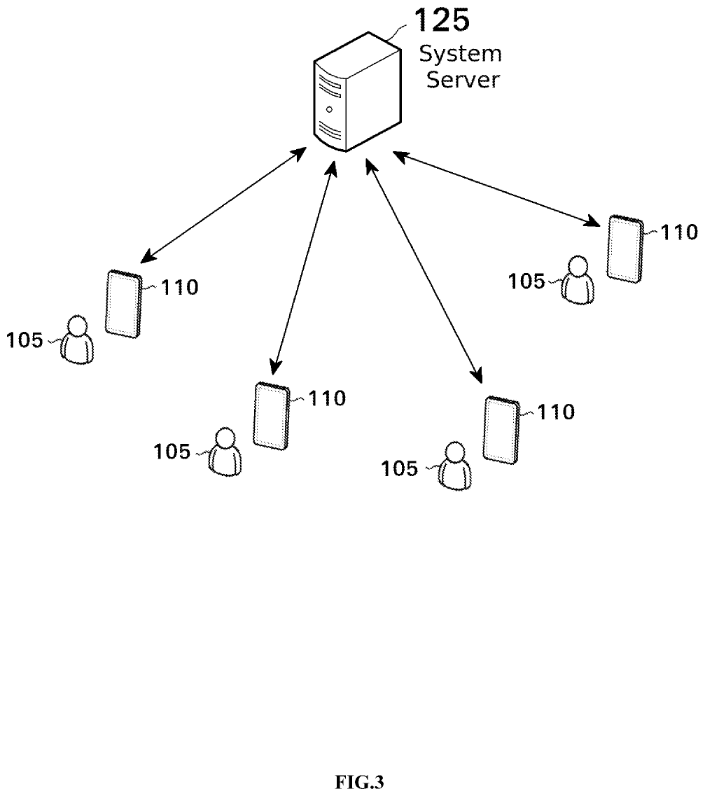

For the implementation of this method the system server 125, containing at least one data processing unit and data storage means, is connected to the specified environment 100 of communication devices by means of a network. With reference to FIG. 3, one can assume that the system server 125 is communicating via WebSockets, and the devices 110 are connected to server 125 using the WebSockets protocol to transmit data to server 125 and receive data from server 125. For the ease of description FIG. 3 shows one server that supports WebSockets communication, but there can be two or more servers.

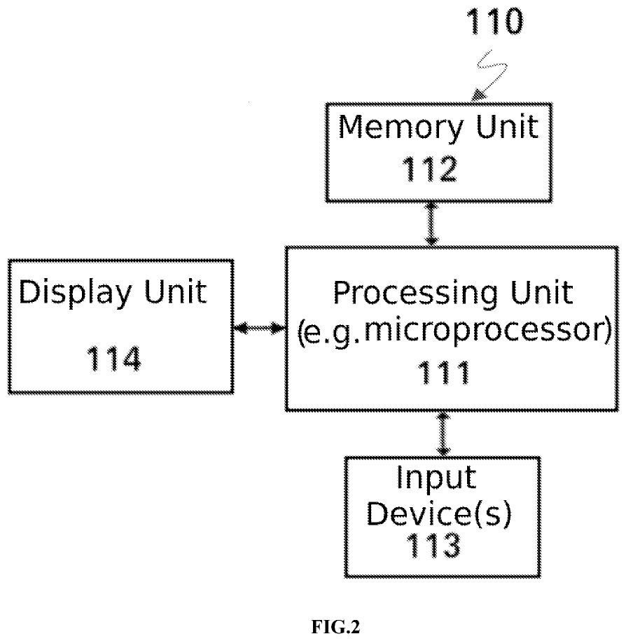

Further, FIG. 2 illustrates an electronic device 110 as a general purpose computing device. Components of the electronic device 110 can include, but are not limited to, at least one processing unit 111, at least one memory unit 112, a bus connecting various system components (including memory unit 112 and processing unit 111), one or more input devices 113 enabling the user to enter data and commands into the system (such input devices may be a keypad, a keyboard, a touchpad, or a composite touchpad), a display unit 114, etc.

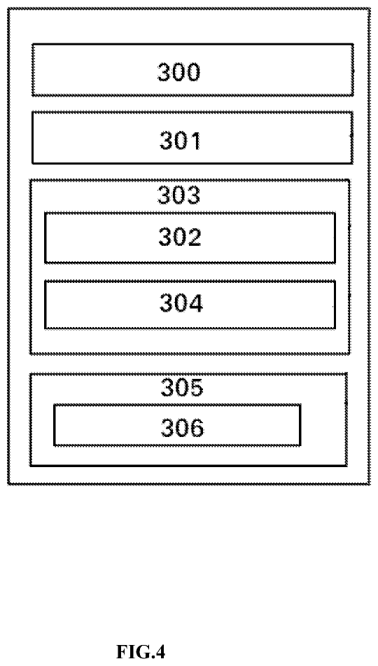

With reference to FIG. 4 which shows a web co-browsing system, below is the description of the main modules of the system.

The sharing confirmation module 300 is configured to receive the selected shared content and shared platform. In the embodiments, the shared platform can be selected from various websites or other suitable shared platforms.

The platform login verification module 301 is configured to navigate to a unified verification interface, so that the user can log into the corresponding shared platform only through the verification interface. As disclosed in various embodiments, decentralized verification processes can be combined into a unified verification process. In this way, verification processes for various platforms can be unified. Regardless of which platform the user shares the content on, the user can log in through the unified verification interface by entering login information corresponding to the shared platform. More specifically, the user can log in to the shared platform after logging in to the system and the system verification of the user account, or after entering the unified key.

The virtual room creation module 302 is configured to activate a code on an input device to create one or more private co-browsing rooms, the room being generated on request of one of the users and representing all software components and/or infrastructure that are required for screen sharing, and/or co-browsing, and/or supporting voice and video communication. A room is a private communication channel enabling the device 115 to transmit its web browsing screen and all other events such as mouse position, mouse movement, page scrolling, page refresh, chat messages etc. in real time to the server 125 and to end-user devices and from them.

The sharing determination module 303: when the user's request to initiate co-browsing is accepted, server 125 accepts it and detects the contacts of other participants/users connected to the virtual room module, and enables them to use the process of receiving events during a specific session. In some embodiments, a cache is used to store requests specific to one or more users. In some embodiments, the co-browsing process is terminated when the user initiating the co-browsing session logs out. In other embodiments, the shared session continues and the end users can update the co-browsing on their devices.

The data communication module 304 is configured to provide website content to the shared platform for sharing. This module provides connection via the device of the first user and transmission of the updated state of websites using the WebSockets protocol to other participants.

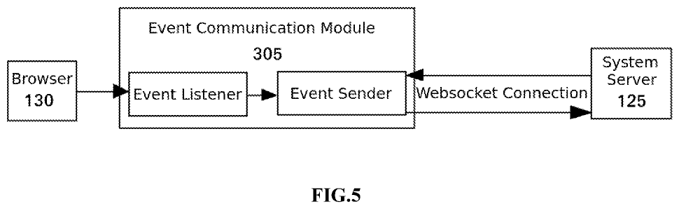

The event communication module 305 is configured to generate a record of user actions, the record including input device events (a mouse, a scroll, a keyboard, a touchpad, Drag and Drop) and visual events, and these events being saved in the “JavaScript Object Notation” (JSON) format, and to send a JSON file to the server via WebSockets 126 (module 304). The structure of the module is shown in FIG. 5.

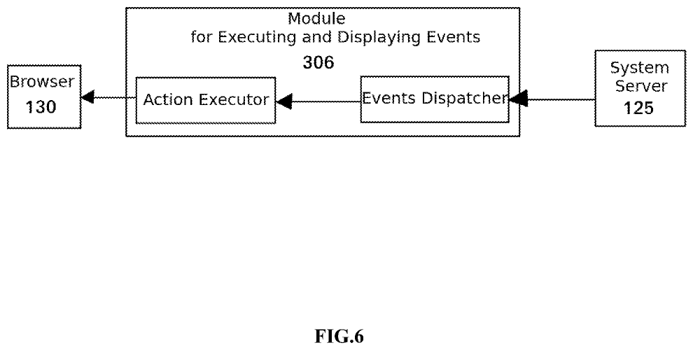

The module 306 for executing and displaying events (Event Manager) on an end-user/participant device is configured to transmit events from the system server to end-user/participant devices. The structure of the module is shown in FIG. 6.

Event manager and action executor methods exist in executable JavaScript. The manager is launched when a message is received from the server.

The event manager has the following functions:
captures the JSON message from the server;
distinguishes the type of event by the type of message;
converts JSON message attributes to variables and/or objects (i.e. events, images, text, HTML, executable JavaScript, etc.);
generates a browser event object and fills its attributes with variables and/or derived objects from the message;
calls up a specific action executor based on the type of event received from the message and transmits the event object to this action executor.

The action executor:
captures the event object from the event manager;
calls up the browser and makes it execute this action using browser events.

In various aspects of the invention, communication between device 110, communications network 115, and server 125 can be implemented via, for example, Hypertext Transfer Protocol Secure (HTTPS) using encryption algorithms such as AES and real-time communications (WebRTC). The WebRTC technology is used to transmit video and audio data streams, which provides streaming audio data, video data, and other content from and to the browser 130 in real time mode without installing plugins or other extensions.

### DETAILED DESCRIPTION

The following terms listed below will be used in the description of the present invention:

Event: any user action—move, click, double-click, drag and drop, etc.

Browser event handler: a function that will be called up when this event occurs on the specified element.

User: a person using the system, being the creator of the virtual room.

Participant: a person using the system, being invited to the room for co-browsing.

Browser: a third-party application used for browsing the web. System Server: the central server of the co-browsing system that hosts co-browsing sessions.

External Server: a third-party system that hosts a website with a built-in co-browsing plugin.

CVM (Chromium Virtual Machine): a third-party application used as a component for manipulating the website content remotely, emulating a regular browser.

The proposed invention is illustrated by the embodiment of the method for co-browsing a web page.

Embodiments of the present invention comprise the stage of a virtual room creation and initial display of the website without built-in plugins, and this stage includes the following steps:

Step 1: The user, using an electronic device, opens (goes to) a website for co-browsing.

Step 2: The system server returns the co-browsing of the landing web page.

Step 3: The user specifies a website for co-browsing.

Step 4: The user clicks the “Co-browse” button.

Step 5: The user's browser is redirected to a script page that generates and sends a message to the system server with the web-URL.

Step 6: The system server receives a message from the user's electronic device and parses it.

Step 7: The system server generates a virtual room and assigns it a unique room ID based on the content of the message. The session identifier can include a generated alphanumeric character set and saves the specified ID for all existing and future co-browsing participants.

Step 8: The system server creates a “virtual user” instance for this user. Step 9: The system server activates a local (on the server) CVM instance and assigns it the ID of this room.

Step 10: The system server passes the URL to CVM with a call up to load the website at that URL.

Step 11: CVM loads the website into virtual memory and responds to the system server that the loading is complete.

Step 12: The system server receives a “complete loading” command from CVM and responds to CVM with an invitation to:

a) take a screenshot of the website and send it as a message.

b) take a static HTML snapshot of the website, excluding all DHTML components, and pass it as a message.

Step 13: CVM receives the message from the system server, takes a screenshot and a snapshot, and transmits them as two separate messages to the system server.

Step 14: The system server receives messages from CVM and generates an HTML page with three iFrames:

iFrame 1: website content as a PNG screenshot,

iFrame 2: co-browsing controls,

iFrame 3: an HTML snapshot of the website.

Step 15: The system server assigns the specified HTML-code of the virtual room and sends it to all users with the same room ID.

The user's browser displays the HTML code specified to the user. Embodiments of the present invention comprise the stage of participant invitation.

Pre-conditions: the user has a browser running with an opened room for co-browsing having a specific website loaded for co-browsing (Step 15).

The stage of participant invitation includes the following steps:

Step 16: The user copies the room URL to the clipboard and passes the URL to participants in any possible way (outside the scope of the application).

Step 17: A participant joins the room in any possible way, opens the browser and loads the provided link.

Step 18: The browser opens the website for co-browsing by calling up the system server via the provided URL.

Step 19: The System Server:
parses the room ID from the provided URL;
creates a virtual participant instance in this room for this participant;
refreshes the HTML page (Step 14), adding participant information to all important controls and frames;
returns the updated HTML code to all active browsers of users and participants.

Step 20: The user's browser and the participants' browsers display the specified HTML code to the user and the participants.

Embodiments of the present invention comprise the stage of a web page co-browsing.

Pre-conditions: the user and the participant(s) have a browser running with an opened room for co-browsing having a specific website loaded for co-browsing (Step 20).

The stage of a web page co-browsing includes the following steps:

Step 21: Any room member (the user or the participant) performs an action (for example, mouse move, click, text entry, etc.).

Step 22: This member's browser captures the action via a browser event handler.

Step 23: The browser transforms the action and its properties into a JSON message, adding the room ID and the participant/user ID of this participant/user.

Step 24: The browser sends this message to the system server via the WebSockets protocol.

Step 25: The system server captures and parses the message, transforming it into an event and an owner.

Step 26: The system server:
transfers the event and the owner to CVM;
sends the message to all participants in the room.

Step 27: Browsers display a “loading” notification.

Browsers capture the message and process it locally, displaying a “loading” notification to users/participants.

Step 28: CVM executes the event on the website and saves the owner in the memory.

Step 29: After executing the event, the updated state of the website is captured by CVM through a screenshot and an HTML snapshot being taken (See Steps 12-13). CVM attaches the owner back to messages with the website screenshot and the website HTML snapshot.

Step 30: CVM transfers the website screenshot and the website HTML snapshot as two separate messages to the system server.

Step 31: The system server:
receives messages from CVM and re-generates an HTML page with three iFrames based on new data from CVM:

iFrame 1: website content as a PNG screenshot;

iFrame 2: co-browsing controls;

iFrame 3: an HTML snapshot of the website;
assigns the specified HTML code to the room ID as per the owner ID received from CVM and sends it to all users with the same room ID.

Step 32: All users/participants' browsers stop performing the “loading” action and display the specified HTML.

Embodiments of the present invention comprise the stage of room creation and the initial display of a website with built-in plugins.

Pre-conditions: the user has a browser running with an opened blank (empty) tab.

The stage of room creation and initial display of a website with built-in plugins includes the following steps:

Step 33: The user, using an electronic device, opens (goes to) a website for co-browsing with a built-in plugin.

Step 34: The user clicks the “Co-browse” button.

Step 35: The browser on the user's device sends a request to the external system to create a co-browsing session.

Step 36: The external site system:
captures the request from the browser;
establishes a WebSockets connection with the system server;
sends a request to create a room, including technical information on browser type, screen resolution, etc.

Step 37: The system server:
captures the request from the external system;
parses the request;
creates a room and assigns it a unique room ID;
saves this ID for all existing and future participants;
generates an iFrame with co-browsing controls based on received technical information (browser type, resolution, etc.);
sends a message with the room ID to the external system;
sends a request to inject the iFrame to the external system;
passes the room ID to the external system.

Step 38: The external system:
captures the room ID and stores it;
captures the iFrame and injects it into the website body;
re-sends the updated website body to the user's browser, including the room ID.

Step 39: The browser on the user's device:
accepts the new website body content;
stores the room ID as a part of the website content (for example, via a cookie, a link attribute, etc.);
refreshes the content displayed for the user on the screen showing co-browsing controls.

Embodiments of the present invention comprise the stage of participant invitation.

Pre-conditions: the user has a browser running with an opened room for co-browsing having some website loaded for co-browsing (Step 39).

The stage of participant invitation includes the following steps:

Step 40: The user:
copies the link to the room by clicking on a button or any other applicable way (UI design-based);
passes the URL to the participants in any possible way.

Step 41: The participant joins the room in any possible way and opens the browser and loads the provided link.

Step 42: The browser on a participant's device calls up the external system to load the website.

Step 43: The external system:
parses the link and captures the room ID;
collects technical information (screen resolution, browser type, etc.) from the participant's browser;
calls up the system server to add the participant to the room and passes technical information.

Step 44: The system server:
captures the call from the external system;
creates a virtual participant instance in this room for this participant;
generates an iFrame with co-browsing controls based on the received technical information (browser type, resolution, etc.);
sends a request to inject the iFrame to the external system and passes its content;
sends a message to display a new member in the participant list to all instances of external systems in this room.

Step 45: The external system (this participant instance):
captures the iFrame and injects it into the website body;
updates the list of room attendees by adding a new participant;
sends the updated website body to the participants' browser, including the room ID.

Step 46: The external system (all other room attendees instances):
captures the message of a new attendee from the system server;
calls up all room attendees' browsers to add a new participant to the attendees list.

Step 47: The browser on a participant's device:
displays the website content;
stores the room ID as a part of the website content (for example, via a cookie, a link attribute, etc.).

Step 48: The browser on all other room attendees:
accepts the message from the external system;
refreshes the page to display the new participant in the attendees list and shows its pointer on the screen.

Embodiments of the present invention comprise the stage of co-browsing the page with built-in plugins and events handling.

Pre-conditions: the user and the participant/s have a browser running with an opened room for co-browsing having a website (with a built-in plugin) loaded for co-browsing (Step 47, Step 48).

The stage of co-browsing the page with built-in plugins and events handling includes the following steps:

Step 49: Any room member (the user or the participant) performs an action (for example, mouse move, click, text entry, etc.).

Step 50: This member's browser:
captures the action via the browser event handler;
transforms the action and its properties into a JSON message, adding the room ID and the participant/user ID;
executes this action for this member (the external system instance);
sends this message to the system server via the WebSockets protocol.

Step 51: The system server:
captures and parses the message, transforming it into 2 entities—an event and an owner;
regenerates this message to exclude the owner and include all other attendees;
sends this message to all room members (the external system instances) for execution.

Step 52: The external system (all other attendees instances):
captures the message, parses and executes it on the website instance;
sends the updated website state to the browser.

Step 53: The browser (all other attendees instances):
accepts the message from the external system;
refreshes the page to display the updated website state.

The above steps are intended to explain the illustrated exemplary embodiments, and it can be assumed that the current state of the art will change the way specific functions are performed. Thus, the description given herein is for the purposes of illustration and not limitation. For example, the stages or steps disclosed herein are not limited to being performed in the order described, but can be performed in any order, and some stages that are consistent with the disclosed embodiments can be omitted.

A person skilled in the art will also understand that various illustrative logic blocks, modules, and algorithm steps described in accordance with the provided disclosure can be implemented as special-purpose electronic equipment, computer software, or a combination of electronic equipment and computer software. For example, modules/blocks can be implemented by one or more processors to instruct one or more processors to become one or more special-purpose processors for executing instructions stored on a computer-readable storage medium to perform specialized functions of the modules/blocks.

The advantages of the proposed technical solution are described below:
no need to download and install any software;
access from a desktop computer, laptop, tablet, and even a smartphone;
built-in chat and VoIP conference, implemented using the WebRTC technology;
highlighting tools available on the screen, implemented through HTML5 Canvas Library;
secure web session, protected by HTTPS protocol and AES;
possibility to co-browse the web with other people. Co-browsing enables two or more people being in different locations to interact through the same webpage/browser session without requiring to log in or to download plugins;

Co-browsing enables each user:
to co-browse the website;
to provide the pointer of another person who is co-browsing, regardless of the web browser or operating system they are using;
to share the loaded web page on the Internet via web browsing;
to combine it with a live chat, a video chat, or a voice call;
to use tools for highlighting on the screen such as drawing, labeling or field selection, a cursor;
to interact with each other with individual control.

1. A system for co-browsing a web page comprising:
a sharing confirmation module, configured to receive the shared content selected by the user and the shared platform selected by the user;
a platform login verification module, configured for navigation to a unified verification interface to verify a registered user and the user's logging into the shared platform through the unified verification interface; and
a virtual room creation module, configured to activate a code on an electronic device to create one or more private co-browsing rooms, the room being generated on request of one of the users and representing all software components and/or infrastructure that are required for screen sharing, and/or co-browsing, and/or supporting voice and video communication;
a sharing determination module, configured to determine a room member who initializes a co-browsing session and to automatically display the content of the session on electronic devices of end users;
a data communication module, configured to provide content to the shared platform for sharing;
an event communication module, configured to generate a record of user actions, the record including events of an input device (a mouse, a scroll, a keyboard, a touchpad, Drag and Drop) and visual events, said events being saved in the “JavaScript Object Notation” (JSON) format, and to send events to the system server as a message via a web connection;
a module for executing and displaying events on the end-user device, configured to transmit events from the system server to the end-user devices.

2. A method for co-browsing a web page, which comprises the steps of:
accepting the shared content selected by the user and the shared platform selected by the user;
navigating to the unified verification interface so that a user can log into the shared platform through the unified verification interface;
creating a virtual room for co-browsing, and assigning a unique room ID to it, and saving the room ID for all participants;
receiving an instruction from the user to perform an action on the web page;
capturing the action via browser event handler;
transforming the action and its properties into a JSON message;
sending the specified message to the system server via the WebSockets protocol;
receiving the message by means of the room end-user device, and refreshing the web page to display the updated website state.
